(19) United States
(12) Patent Application Publication
(10) Pub. No.: US 2004/0122732 A1
(43) Pub. Date: Jun. 24, 2004

(54) Method of selling fuel

(76) Inventor: F. David Comer, O'Fallon, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/328,379

(22) Filed: Dec. 23, 2002

(51) Int. Cl. G06F 17/60

(52) U.S. Cl. 705/14

(57) ABSTRACT

The present disclosure provides a method of selling fuel where the seller receives a membership fee from a fuel purchaser in exchange for the right to purchase discounted fuel in the future. Next, the seller receives a fuel fee from the fuel purchaser in exchange for the right to purchase a specified market value of fuel wherein the market value of the fuel is greater than the fuel fee. The seller then issues the fuel purchaser with a card that allows the fuel purchaser to purchase the amount of fuel having the market value greater than the fuel fee wherein the card is limited to usage only at locations that sell fuel but verifiable over a credit/debit card network not limited to fuel purchases.

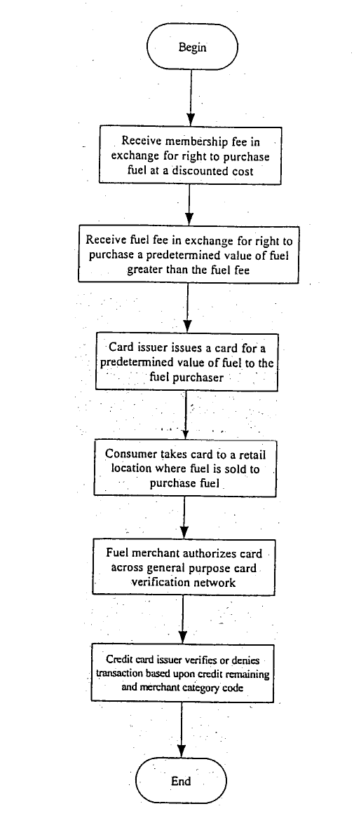

### CROSS-REFERENCE TO RELATED APPLICATIONS

None.

### STATEMENT REGARDING FEDERALLY SPONSORED RESEARCH

None.

### BACKGROUND OF THE INVENTION

1. Field of the Invention

The field of the invention relates generally to a method of selling commodities. More specifically, the field of the invention relates to a method of selling fuel. While the invention is discussed with respect to a particular application, those skilled in the art will recognize the wider application of the invention disclosed hereinafter.

2. Description of Related Art

In the past, attempts have been made to provide alternative methods of selling fuel. For example, U.S. Pat. No. 6,332,128 discloses a method of cross-marketing gasoline and other products by awarding price-per-unit discounts to a consumer purchasing gasoline who has first purchased a specified value or quantity of another product. U.S. Pat. No. 6,321,984 discloses a system that tracks a customer's previous purchasing levels and rewards a reduced price per unit discount for gasoline after the customer has purchased a specified amount of gasoline.

Particularly, most prior art methods of selling gasoline focus on providing price-per unit individual discounts. However, nothing in the prior art discloses a system whereby a fuel customer can purchase the right to buy a specified value in fuel at a fixed, reduced price. Additionally, most prior art methods of selling gasoline do not provide a card to the fuel purchaser that can be verified across a card verification network, that network is not being limited to fuel purchases while at the same time operating to limit purchases with the card to establishments that sell fuel.

### BRIEF SUMMARY OF THE INVENTION

In the broadest aspect, the present invention provides a method of selling fuel where the seller receives a membership fee from a fuel purchaser in exchange for the right to purchase discounted fuel in the future. Next, the seller receives a fuel fee from the fuel purchaser in exchange for the right to purchase a specified market value of fuel wherein the market value of the fuel is greater than the fuel fee. The seller then issues the fuel purchaser with a card that allows the fuel purchaser to purchase the amount of fuel having the market value greater than the fuel fee wherein the card is limited to usage only at locations that sell fuel but verifiable over a credit/debit card network not limited to fuel purchases.

### BRIEF DESCRIPTION OF THE DRAWING

The FIGURE is flow chart showing the process of the present invention.

### DESCRIPTION OF THE PREFERRED EMBODIMENT

While the invention is susceptible of embodiment in many different forms, there is shown in the drawings and described in detail preferred embodiments of the invention. It is to be understood that the present disclosure is to be considered only as an example of the principles of the invention. This disclosure is not intended to limit the broad aspect of the invention to the illustrated embodiments. The scope of protection should only be limited by the claims.

Referring to the FIGURE, the preferred embodiment of the invention comprises, in a first step, receiving a membership fee from a fuel purchaser in exchange for the right to purchase discounted fuel in the future. The seller may be a membership organization of the purchasers, a producer or distributor of gasoline or a third party organization in the business of providing the method of the present invention. Preferably, the membership fee is about 50% of the savings a person would achieve by remitting the maximum number of fuel fees (described below). As will be appreciated other fee arrangement will become apparent to one skilled in the art. Additionally, the membership fee only allows the fuel purchaser the right to remit fuel fees (described below) for a specified period of time, such as one year.

In a second step, the seller receives a fuel fee from the fuel purchaser in exchange for the right to purchase a specified market value of fuel. The market value of the fuel is an amount greater than the fuel fee. Preferably, the fuel fee represents 80% of the value of the fuel. Again, other arrangements will become apparent to one skilled in the art. The fuel purchaser may remit no more than a maximum number of fuel fees, that maximum preferably being fifteen. If the fuel purchaser remits eight or more fuel fees, the purchaser realizes a savings in fuel over the membership fee previously remitted.

In a third step, the seller issues to the fuel purchaser a card that allows the fuel purchaser to purchase the amount of fuel having the market value greater than the fuel fee. As a result, the user of the card may make a single fuel purchase for the entire value of the card or a series of fuel purchases until the value of the card has been exhausted. Preferably, the card is a prepaid debit card wherein an amount of money equal to the dollar value of the card has been placed on deposit with a card issuer and is withdrawn by the card issuer and paid to fuel merchants as the fuel purchaser uses the card. However, alternatively, the card can be a card that is purchased from the card issuer for the face value or a dollar value below face value. A “card issuer” is an individual or organization that issues credit or debit cards and maintains a card verification network at retail locations across the country and/or the world.

Next, a fuel purchaser takes the card to a retail establishment that sells fuel and uses it to purchase fuel. The card issued by the card issuer is limited to usage only at locations that sell fuel. However, the card is verifiable over the card issuer's nationwide card verification network. The advantage of using a card that is verifiable over existing nationwide verification networks but limit to establishments that sells fuel is apparent from the fact that a separate card and card verification network does not have to be established by one who practices the present method.

While the card issuer's verification network extends to retail locations that sell every sort of good or service, the card issuer associates the card number with a set of allowable Merchant Category Codes (MCCs) that identify locations that sell fuel. As a result, the card issuer only authorizes transactions that occur at locations having the proper MCC for fuel sales. Because the card issuer limits transactions by merchant type and not the specific goods purchased from the merchant, the card may be used for goods or services other than fuel provided that the location where the transaction takes place has a MCC that indicates that it also sells fuel.

While the specific embodiments have been illustrated and described, numerous modifications come to mind without significantly departing from the spirit of the invention, and the scope of protection is only limited by the scope of the accompanying claims.

I claim:

1. A method of selling fuel comprising:
receiving a membership fee from a product purchaser in exchange for the right to purchase a predetermined discounted product in the future;
receiving an activity fee from the product purchaser in exchange for the right to purchase a specified market value of product wherein the market value of the product is greater than the activity fee;
issuing to the product purchaser a card that allows the product purchaser to purchase the product having the market value greater than the activity fee wherein the card is limited to usage only at locations that sell the product but verifiable over a credit/debit card network not limited to the predetermined product purchases.

2. The method of claim 1 wherein the product is gasoline.

3. The method of claim 2 wherein the activity fee is 80% of the value of the purchasable fuel.

4. The method of claim 2 wherein the card is encoded with data that indicates to the credit/debit card network that the card is only for use at locations having an MCC code that indicates the location sells fuel.

5. The method of claim 1 wherein the card is usable only for a specified period from issue.

6. The method of claim 5 wherein the card is usable only for six months from issue.

7. The method of claim 1 wherein the product purchaser may not remit more than a maximum number of activity fees.

8. A method of selling fuel comprising:
receiving a membership fee from a fuel purchaser in exchange for the right to purchase discounted fuel in the future;
receiving a fuel fee from the fuel purchaser in exchange for the right to purchase a specified market value of fuel wherein the market value of the fuel is greater than the fuel fee;
issuing the fuel purchaser with a card that allows the fuel purchaser to purchase the amount of fuel having the market value greater than the fuel fee wherein the card is limited to usage only at locations that sell fuel but verifiable over a credit/debit card network not limited to fuel purchases.

9. The method of claim 7 wherein the fuel is gasoline.

10. The method of claim 7 wherein the discounted fee is 80% of the value of the purchasable fuel.

11. The method of claim 7 wherein the card is encoded with data that indicates to the credit/debit card network that card is only for use at locations having an MCC code that indicates the location sells fuel.

12. The method of claim 7 wherein the card is usable only for a specified period from issue.

13. The method of claim 11 wherein the card is usable only for six months from issue.
